(19) United States
(12) Patent Application Publication
(10) Pub. No.: US 2006/0036633 A1
(43) Pub. Date: Feb. 16, 2006

(54) System for indexing ontology-based semantic matching operators in a relational database system

(75) Inventors: Eugene Inseok Chong, Concord, MA (US); George Eadon, Nashua, NH (US); Jagannathan Srinivasan, Nashua, NH (US); Souripriya Das, Nashua, NH (US)

Correspondence Address: CHARLES G. CALL, 68 HORSE POND ROAD, WEST YARMOUTH, MA, 02673-2516, US

(73) Assignee: Oracle International Corporation, Redwood Shores, CA (US)

(21) Appl. No.: 10/916,585

(22) Filed: Aug. 11, 2004

(51) Int. Cl. G06F 7/00

(52) U.S. Cl. 707/101

(57) ABSTRACT

A method for rapidly identifying terms that are associated with a given root term by a transitive relationship defined by hierarchical ontology data stored in a relational database. A transitive closure table is created that comprises a plurality of rows each of which specifies a term and an associated one of a plurality of root terms. The table is sorted and indexed by the root terms to group together rows associated with each of said root terms. The resulting transitive closure table may be consulted to rapidly identify terms associated with said given root term.

### FIELD OF THE INVENTION

This invention relates to methods and apparatus for storing and processing ontology data within a relational database management system (RDBMS).

### BACKGROUND OF THE INVENTION

A single term often has different meanings in different contexts: the term “mouse” may refer to an animal in one context or to a computer input device in another. Different terms can mean the same thing, like the terms “TV” and “television.” And terms may be related to one another in special ways; for example, a “poodle” is always a “dog” but a “dog” is not always a “poodle”.

Humans learn to cope with the ambiguity of language by understanding the context in which terms are used. Computers can be programmed to do the same thing by consulting data structures called “ontologies” that represent terms and their interrelationships.

Data processing operations commonly need to match one term against another. Because a single term can have different meanings in different contexts, and different terms can mean the same thing, simply testing two values for equality often isn't sufficient. Consider, for example, a computerized restaurant guide application that recommends restaurants to a user based on her preferences. Such an application might employ a database table called “served_food” that identifies each restaurant by its ID number “R_id” in one column and by the kind of food it serves in a second column called “Cuisine.” In the absence of semantic matching, if the user wished to identify restaurants serving Latin American cuisine, a conventional database application would most likely resort to a syntactic matching query using an equality operator as illustrated by the following SQL SELECT statement:

SELECT * FROM served_food WHERE cuisine=‘Latin American’;

But this query would not identify restaurants listed as serving “Mexican,” “Spanish,” or “Portuguese” cuisine, since none of those terms identically match the term “Latin American” used in the query.

More meaningful results could be obtained by performing semantic matching which would take into account the meaning of terms. To do that, the matching process could consult an ontology like the on shown graphically in FIG. 1 which shows that the term ‘Latin American” encompasses the more specific cuisine types identified by the terms “Mexican,” “Spanish” and “Portuguese.”

The equality operation commonly used in a conventional database system only allows for matching based on the structure of the data type and doesn't take into account the semantics pertaining to a specific domain. Semantic meaning can be specified by one or more ontologies associated with the domain. In recent years, mechanisms for handling ontologies have received wide attention in the context of semantic web. See, for example, “The Semantic Web” by T. Bemers-Lee, J. Hendler and O. Lassila in Scientific American, May, 2001. Tools for building and using ontologies have become available and include, for example: (1) OntologyBuilder and OntologyServer from VerticalNet described by A. Das, W. Wu, and D. McGuinness in “Industrial Strength Ontology Management,” The Emerging Semantic Web, IOS Press, 2002, and (2) KAON described by B. Motik, A. Maedche, and R. Volz in “A Conceptual Modeling Approach for Semantics-Driven Enterprise Applications,” Proceedings of the 2002 Confederated Int. Conferences DOA/CoopIS/ODBASE, 2002. These tools permit ontologies to be stored in a relational databse, and provide a procedural API (application program interface) for accessing and manipulating the ontologies. To incorporate ontology-based semantic matching into an application, however a user needs to make use of the provided APIs to first query the ontology and then combine the results from the API with queries on database tables, a process that is burdensome to the user and requires additional processing.

An ontology is a shared conceptualization of knowledge in a particular domain. A formal specification of an ontology facilitates building applications by separating the knowledge about the target domain from the rest of the application code. This separation substantially simplifies the application code, makes it easier to share the knowledge represented by the ontology among multiple applications, and allows that knowledge to be expanded or corrected without requiring changes to the application.

Relational database systems that are in widespread use utilize ontologies to provide improved results. To achieve that, however, the existing capabilities of the RDBMS must be expanded to provide semantic matching between syntactically different terms or sometimes between syntactically same, but semantically different terms.

The semantic matching typically involves computing transitive closure for terms related by a property that is transitive in nature (for example, IS_A relationship). However, finding transitive closure from an ontology can be a time-consuming process, especially if the ontology has a large number of terms. In addition, the existence of different relationship types can further increase the computation cost.

It is accordingly a principle object of the present invention to provide methods for speeding the execution of database queries which consult ontology data.

### SUMMARY OF THE INVENTION

The present invention takes the form of a method for rapidly identifying terms that are associated with a given root term by one or more relationships as defined by hierarchical ontology data stored in a relational database.

In its preferred embodiment, the present invention creates and uses a transitive closure table comprising a plurality of rows each of which specifies a root term and an associated term which is related to the root term by a specified type of relationship. The transitive closure table is sorted and indexed by the values of the root terms to group together rows associated with each of said root terms. To speed queries on a relational data table, the invention also may employ a term-to-row-identifier mapping index to that table to more rapidly execute SQL queries which identify terms stored in the table that semantically match terms specified in the queries.

The preferred transitive closure table stores quadruplets of the form <ontology, rootterm, relation, term>. Thus, for a given <rootterm, relation>, multiple rows will be present in the table which together represent the transitive closure. The transitive closure table can be implemented as key-compressed index-organized table (essentially a primary B+-tree).

The preferred row-identifier mapping table contains <term, row-identifier> pairs and may also be implemented as key-compressed index-organized table.

The pre-computed transitive closure table may be consulted by itself to satisfy queries that seek information contained in the ontology data. Rather than computing the transitive closure each time a query is submitted, a special operator placed in a query may be used to simply consult the transitive closure table and return the desired information from the ontology.

Distance and path measures may also be maintained as part of transitive closure table. In this way, the transitive closure table may be used to directly satisfy queries that employ special operators that find the distance or path between two terms. That is, the transitive closure table maintains records of the form <ontology, rootterm, relation, term, distance, path>. Thus, in addition to retrieving row-identifiers, the distance and path measures can also be obtained from the transitive closure table. The transitive closure table may maintain the shortest distance and path between terms, all distances and paths between terms, or both. When all distances and paths between terms are maintained, a nested table may be used so that all distances and paths between two terms can be associated with a single row of the transitive closure table. The transitive closure table also permits queries that seek all terms related to a root term regardless of distance and path.

As described in the detailed description to follow, the invention may be implemented using the extensible indexing framework provided by the database.

The creation of the transitive closure table is preferably performed concurrently with registering the ontology with the database. When the ontology is updated, the transitive closure table is rebuilt to incorporate the new changes.

The present invention can optimize queries that consult an ontology by employing the transitive closure table and the term-to-row identifier table which are implicitly created and managed by the RDBMS using its extensible indexing framework.

These and other features and advantages of the present invention may be better understood by considering the following detailed description of a preferred embodiment of the invention

### BRIEF DESCRIPTION OF THE DRAWINGS

In the detailed description which follows, frequent reference will be made to the attached drawings, in which:

FIG. 1 is graph depicting a illustrative ontology that defines hierarchical relationships between terms used to describe food served by restaurants; and

FIG. 2 is a block diagram illustrating the principle data structures used to implement the preferred embodiment of the invention;

FIG. 3 is a diagram illustrating the addition of an EQV relationship;

FIG. 4 is a diagram illustrating the manner in which indexing is used to speed term matching operations;

### DETAILED DESCRIPTION

1. Introduction

The present invention employs a set of SQL (Structured Query Language) operators to perform ontology-based semantic matching on data stored in a relational database management system (RDBMS). These SQL operators preferably take the form of extensions to the pre-existing SQL syntax employed by the database and may be implemented with the database extensibility capabilities (namely, the ability to define user-defined operators, user-defined indexing schemes, and table functions) typically available in a robust database system.

The specific embodiment of the invention described below has been implemented on top of the existing SQL syntax used in the Oracle family of databases. Detailed information on the Oracle SQL language and its syntax can be found in the Oracle 8i SQL Reference available from Oracle Corporation. This reference contains a complete description of the Structured Query Language (SQL) used to manage information in an Oracle database. Oracle SQL is a superset of the American National Standards Institute (ANSI) and the International Standards Organization (ISO) SQL92 standard. The preferred embodiment supports ontologies specified in Web Ontology Language (OWL [OWL Web Ontology Language Reference, http://www.w3.org/TR/owlref, specifically, OWL Lite and OWL DL) by extracting information from the OWL document and then storing this information in the schema.

The ontology-based operators and the indexing scheme employed in the preferred embodiment uses Oracle's Extensibility Framework as described by J. Srinivasan, R. Murthy, S. Sundara, N. Agarwal and S. DeFazio in “Extensible Indexing: A Framework for Integrating Domain-Specific Indexing into Oracle 8i,” Proceedings of the 16th International Conference on Data Engineering, pages 91-100, 2000. Specifically, the ONT_RELATED, ONT_DISTANCE, and ONT_PATH operators are implemented as user-defined operators and ONT_EXPAND is implemented as a table function. The operator implementation typically requires computing transitive closure, which is performed in Oracle SQL using queries with a CONNECT BY clause. Indexing is implemented as a user-defined indexing scheme. Although the ontology-based functions are described below in the context of an Oracle RDBMS, these functions can be supported in any RDBMS that supports the same basic capabilities provided by the Oracle RDBMS.

Before considering in detail how ontology-based matching and related functions are implemented, it will be useful to first consider how these operators might be used to provide the kind of semantic matching needed for the restaurant guide application noted in the background section above. To search the served_food database table for restaurants serving Latin American cuisine, the following SELECT statement might be used:

SELECT * FROM served_food WHERE ONT_RELATED (Cuisine, ‘IS_A’, ‘Latin American’, ‘Cuisine_ontology’)=1;

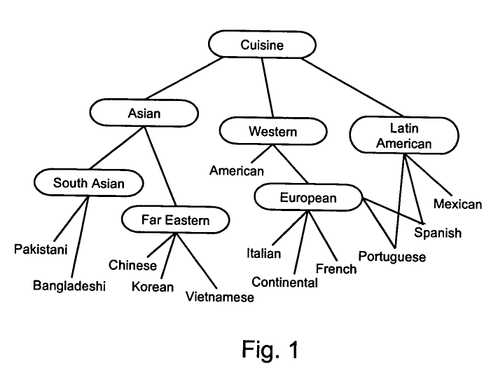

The ONT_RELATED operator in the statement above evaluates two input terms, a value from the Cuisine column in the table served_food and the string argument ‘Latin American’. The ONT_RELATED operator consults the specified ontology ‘Cuisine_ontology’ for the meaning of the two terms (shown graphically in FIG. 1) . If the operator determines that the two input terms are related by the input relationship type argument ‘IS_A’ by the ontology, it will return 1 (true), otherwise it returns 0 (false). The query thus identifies rows containing cuisines that are related to ‘Latin American’ based on the ‘IS_A’ relationship in the specified ontology and context, and would identify restaurants 2 and 14 which serve ‘Mexican’ and ‘Portuguese’ cuisine. The ONT_RELATED operator thus allows a user to introducing ontology-based semantic matching into SQL queries.

Optionally, as explained later in more detail, a user may want to get a measure for the rows identified by the ONT_RELATED operator. This can be achieved by using the ONT_DISTANCE ancillary operator. The ONT_DISTANCE operator gives a measure of how closely the terms are related by measuring the distance between the two terms. For example, the user may request that the results of the semantic matching query be sorted on this distance measure by submitting the following query:

SELECT * FROM served_food WHERE ONT_RELATED (cuisine, ‘IS_A’, ‘Latin American’, ‘Cuisine_ontology’, 123)=1 ORDER BY ONT_DISTANCE (123);

In this query, the integer argument 123 in ONT_DISTANCE identifies the filtering operator expression (ONT_RELATED) that computes this ancillary value. Similarly, another ancillary operator named ONT_PATH may be used to compute the path measure value between the two terms. Ancillary operators are described by R. Murthy, S. Sundara, N. Agarwal, Y. Hu, T. Chorma and J. Srinivasan in “Supporting Ancillary Values from User Defined Functions in Oracle”, In Proceedings of the 19th International Conference on Data Engineering, pages 151-162, 2003.

In addition, a user may want to query an ontology independently (without involving user tables). The ONT_EXPAND operator described below can be used for this purpose.

Providing ontology-based semantic matching capability as part of SQL greatly facilitates developing ontology-driven database applications. Applications that can benefit include e-commerce (such as supply chain management, application integration, personalization, and auction). Also, applications that have to work with domain-specific knowledge repositories (such as BioInformatics, Geographical Information Systems, and Healthcare Applications) can take advantage of this capability. These capabilities can be exploited to support semantic web applications such as web service discovery as well. A key requirement in these applications is to provide semantic matching between syntactically different terms or sometimes between syntactically same, but semantically different terms.

Support for ontology-based semantic matching is achieved by introducing the following extensions to existing database capabilities:

A. Two new SQL operators, ONT_RELATED and ONT_EXPAND are defined to model ontology based semantic matching operations. For queries involving ONT_RELATED operator, two ancillary SQL operators, ONT_DISTANCE and ONT_PATH, are defined that return distance and path respectively for the filtered rows.

B. A new indexing scheme ONT_INDEXTYPE is defined to speed up ontology-based semantic matching operations.

C. A system-defined ONTOLOGIES table is provided for storing ontologies.

In the description which follows: Section 2 presents an overview of the features which support ontology-based semantic matching operations; and Section 3 discusses the implementation of the ontology-related functions by extending the existing capabilities of an Oracle RDBMS.

2. Supporting Ontology-based Semantic Matching in a Database System

2.1 Overview

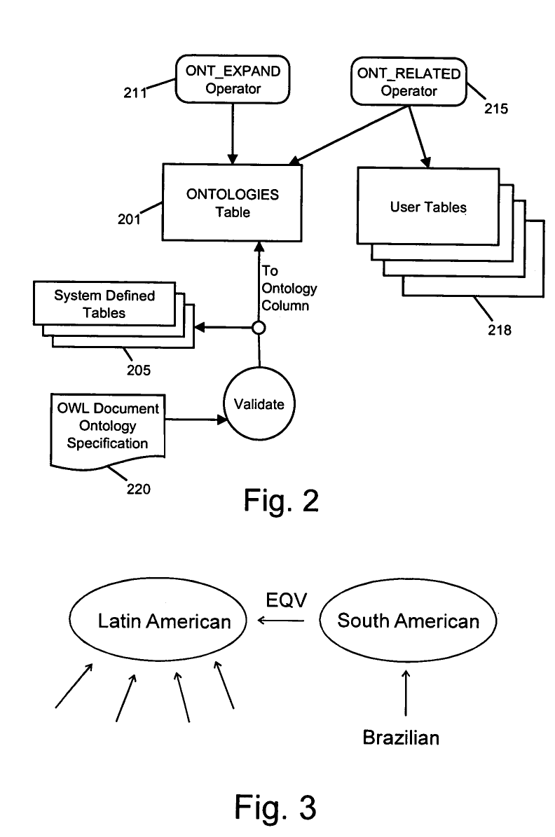

The principle ontology-related data structures and functions used in the preferred embodiment are illustrated in FIG. 2 and may be summarized as follows:

A top-level ONTOLOGIES table seen at 201 holds ontology data, which internally maps to a set of system-defined tables shown at 205.

Two operators are used for querying purposes. The ONT_EXPAND operator 211 can be used to query the ontology independently, whereas the ONT_RELATED operator 215 can be used to perform queries on one or more user tables 218 holding ontology terms whose meaning is specified by ontology data in the system defined tables 205. Optionally, a user can use ancillary operators ONT_DISTANCE and ONT_PATH operators in queries involving the ONT_RELATED operator 215 to get additional measures (distance and path) for the filtered rows extracted by the queries.

2.2 RDBMS Schema for Storing Ontologies

An RDBMS schema has been created for storing ontologies specified in OWL. This RDBMS schema defines the following tables:

Ontologies: Contains basic information about various ontologies, and includes the columns OntologyID, OntologyName, and Owner.

Terms: Represents classes, individuals, and properties in the ontologies, and includes the column TermID, OntologyID, Term, and Type. A term is a lexical representation of a concept within an ontology. TermID value is generated to be unique across all ontologies. This allows representation of references to a term in a different ontology than the one that defines the term. Also, even an OntologyID is handled as a TermID which facilitates storing values for various properties (e.g., Annotation Properties) and other information that applies to an ontology itself. Note that, as a convention, any column in the above schema whose name is of the form “. . . ID . . . ”, would actually contain TermID values (like a foreign key).

Properties: Contains information about the properties, and includes the columns OntologyID, PropertyID, DomainClassID, RangeClassID, and Characteristics. Domain and range of a property are represented with TermID values of the corresponding classes. Characteristics indicate which of the following properties are true for the property: symmetry, transitivity, functional, inverse functional.

Restrictions: Contains information about property restrictions, and includes the columns OntologyID, NewClassID, PropertyID, MinCardinality, MaxCardinality, SomeValuesFrom, and AllValuesFrom. Restrictions on a property results in definition of a new class. This new class is not necessarily named (i.e., ‘anonymous’ class) in OWL. However, internally we create a new (system-defined) class for ease of representation.

Relationships: Contains information about the relationship between two terms, and includes the OntologyID, TermID1, PropertyID, and TermID2.

PropertyValues: Contains <Property, Value> pairs associated with the terms and includes the columns OntologyID, TermID, PropertyID, and Value. In order to handle values of different data types, some combinations of the following may be used: Define separate tables (or separate columns in the same table) for each of the frequently encountered types and use a generic self-describing type (ANYDATA in Oracle RDBMS) to handle any remaining types.

System-defined Classes for Anonymous Classes: We create internal (i.e., not visible to the user) or system-defined classes to handle OWL anonymous classes that arise in various situations such as Property Restrictions, enumerated types (used in DataRange), class definitions expressed as expression involving IntersectionOf, UnionOf, and ComplementOf.

Bootstrap Ontology: The first things that are loaded into the above schema are the basic concepts of OWL itself. In some sense this is like the bootstrap ontology. For example:
Thing and Nothing are stored as Classes.
subClassOf is stored as a transitive (meta) property that relates two classes.
subPropertyOf is stored as a transitive (meta) property that relates two properties.
disjointWith is stored as a symmetric (meta) property that relates two classes.
SameAs is stored as a transitive and symmetric property that relates two individuals in Thing class.

Storing these OWL concepts as a bootstrap ontology facilitates inferencing. A simple example would be the following: If C1 is a subclassOf C2 and C2 is a subclassOf C3, then (by transitivity of subClassOf) C1 is a subclassOf C3. Note that the reflexive nature of subClassOf and SubPropertyOf is handled as a special case.

Loading Ontologies: An ontology is loaded into the database by using an API that takes as input an OWL document. Information from the OWL document is extracted and then stored into the system-defined tables in the RDBMS schema described above.

The Ontologies table stores some basic information about all the ontologies that are currently stored in the database. A portion (view) of this table is visible to the user.

2.3 Modeling Ontology-based Semantic Matching

To support ontology-based semantic matching in RDBMS several new operators are defined.

2.3.1 ONT_RELATED Operator. This operator models the basic semantic matching operation. It determines if the two input terms are related with respect to the specified RelType relationship argument within an ontology. If they are related it returns 1, otherwise it returns 0.

ONT_RELATED (Term1, RelType, Term2, OntologyName) RETURNS INTEGER;

The RelType can specify a single ObjectProperty (for example, ‘IS_A’, ‘EQV’, etc.) or it can specify a combination of such properties by using AND, NOT, and OR operators (for example, ‘IS_A OR EQV’). Note that both Term1 and Term2 need to be simple terms. If Term2 needs to be complex involving AND, OR, and NOT operators, user can issue query with individual terms and combine them with INTERSECT, UNION, and MINUS operators. See

Section 2.3.4 for an example.

RelType specified as an expression involving OR and NOT operators (e.g., FatherOf OR MotherOf) is treated as a virtual relationship (in this case say Ancestorof) that is transitive by nature (also see Section 3.2.5).

2.3.2 ONT_EXPAND Operator. This operator is introduced to query an ontology independently. Similar to ONT_RELATED operator, the RelType can specify either a simple relationship or combination of them.

```
CREATE TYPE ONT_TermRelType AS OBJECT (
  Term1Name VARCHAR(32),
  PropertyName VARCHAR(32),
  Term2Name VARCHAR(32),
  TermDistance NUMBER,
  TermPath VARCHAR(2000)
);
CREATE TYPE ONT_TermRelTableType AS TABLE OF
ONT_TermRelType;
ONT_EXPAND (Term1, RelType, Term2, OntologyName
) RETURNS ONT_TermRelTableType;
```

Typically, non-NULL values for RelType and Term2 are specified as input and then the operator computes all the appropriate <Term1, RelType, Term2> tuples in the closure taking into account the characteristics (transitivity and symmetry) of the specified RelType. In addition, it also computes the relationship measures in terms of distance (TermDistance) and path (TermPath). For cases when a term is related to input term by multiple paths, one row per path is returned. It is also possible that ONT_EXPAND invocation may specify input values for any one or more of the three parameters or even none of the three parameters. In each of these cases, the appropriate set of <Term1, RelType, Term2> tuples is returned.

2.3.3 ONT_DISTANCE and ONT_PATH Ancillary Operators. These operators compute the distance and path measures respectively for the rows filtered using ONT_RELATED operator.

ONT_DISTANCE (NUMBER) RETURNS NUMBER;
ONT_PATH (NUMBER) RETURNS VARCHAR;

A single resulting row can be related in more than one way with the input term. For such cases, the above operators return the optimal measure, namely smallest distance or shortest path. For computing all the matches, the following two operators are provided:

```
ONT_DISTANCE_ALL (NUMBER)
    RETURNS TABLE OF NUMBER;
ONT_PATH_ALL (NUMBER)
    RETURNS TABLE OF VARCHAR;
```

2.3.4 A Restaurant Guide Example. Consider a restaurant guide application that maintains type of cuisine served at various restaurants. It has two tables, 1) restaurants containing restaurant information, and 2) servedfood containing the types of cuisine served at restaurants.

The restaurant guide application takes as input a type of cuisine and returns the list of restaurants serving that cuisine. Obviously, applications would like to take advantage of an available cuisine ontology to provide better match for the user queries. The cuisine ontology describes the relationships between various types of cuisines as shown earlier in FIG. 1.

Thus, if a user is interested in restaurants that serve cuisine of type ‘Latin American’, the database application can generate the following query:

```
SELECT r.name, r.address
FROM served_food sf, restaurant r
WHERE r.id = sf.r_id AND ONT_RELATED(sf.cuisine,
    ‘IS_A OR EQV’, ‘Latin American’,
    ‘Cuisine_ontology’)=1;
```

To query on ‘Latin American’ AND ‘Western’ the application program can obtain rows for each and use the SQL INTERSECT operation to compute the result.

Also, the application can exploit the full SQL expressive power when using ONT_RELATED operator. For example, it can easily combine the above query results with those restaurants that have lower price range.

```
SELECT r.name FROM served_food sf, restaurant r
WHERE r.id = sf.r_id AND ONT_RELATED(sf.cuisine,
    ‘IS_A OR EQV’, ‘Latin American’,
    ‘Cuisine_ontology’)=1 AND r.price_range = ‘$’;
```

2.3.5 Discussion. Note that the queries in section 2.3.4 can also be issued using the ONT_EXPAND operator. For example, the first query in that section can alternatively be expressed using ONT_EXPAND as follows:

```
SELECT r.name, r.address FROM served_food sf, restaurant r
WHERE r.id = sf.r_id AND sf.cuisine IN
    (SELECT Term1Name from TABLE( ONT_EXPAND(NULL,
        ‘IS_A OR EQV’, ‘Latin American’, ‘Cuisine_ontology’)));
```

The ONT_RELATED operator is provided in addition to ONT_EXPAND operator for the following reasons:
The ONT_RELATED operator provides a more natural way of expressing semantic matching operations on column holding ontology terms; and
It allows use of an index created on column holding ontology terms to speed up the query execution by taking column data into account.

2.4 Inferencing

Inferencing rules employing the symmetry and transitivity characteristics of properties are used to infer new relationships. This kind of inferencing can be achieved through the use of the operators defined above (see Section 3.2 for details). Note that our support for inferencing is restricted to OWL Lite and OWL DL, both of which are decidable.

3. Implementation of Ontology Related Functionality on Oracle RDBMS

This section describes how the ontology-related functionality is implemented on top of Oracle RDBMS

3.1 Operators

The ONT_RELATED operator is defined as a primary user-defined operator, with ONT_DISTANCE and ONT_PATH as its ancillary operators. The primary operator computes the ancillary value as part of its processing [97]. In this case, ONT_RELATED operator computes the relationship. If ancillary values (the distance and path measure) are required, it computes them as well.

Note that the user-defined operator mechanism in Oracle allows for sharing state across multiple invocations. Thus, the implementation of the ONT_RELATED operator involves building and compiling an SQL query with CONNECT BY clause (as described in Section 3.2) during its first invocation. Each subsequent invocations of the operator simply uses the previously compiled SQL cursor, binds it with the new input value, and executes it to obtain the result.

The ONT_EXPAND operator is defined as a table function as it returns a table of rows, which by default includes the path and distance measures.

3.2 Basic Algorithm

Basic processing for both ONT_RELATED and ONT_EXPAND involves computing transitive closure, namely, traversal of a tree structure by following relationship links given a starting node. Also, as part of transitive closure computation, we need to track the distance and path information for each pair formed by starting node and target node reached via the relationship links.

Oracle supports transitive closure queries with CONNECT BY clause as follows:

SELECT . . . FROM . . . START WITH <condition> CONNECT BY <condition>;

The starting node is selected based on the condition given in START WITH clause, and then nodes are traversed based on the condition given in CONNECT BY clause. The parent node is referred to by the PRIOR operator. For computation of distance and path, the Oracle-provided LEVEL psuedo-column and SYS_CONNECT_BY_PATH function are respectively used in the select list of a query with CONNECT BY clause.

Note that in the system-defined Relationships table, a row represents ‘TermID1 is related to TermID2 via PropertyID relationship.’ For example, if ‘A IS_A B’, it is represented as the row <1, A, IS_A, B> assuming that the ontologyID is 1.

Note that any cycles encountered during the closure computation will be handled by the CONNECT BY NOCYCLE query implementation available in Oracle 10g (not explicitly shown in the examples below). Also, the proposed index-based implementation (described in Section 3.3) can handle this case even in Oracle 9i Release 2.

For simplicity, we use a slightly different definition for the relationships table where term names are stored instead of termIDs. In this case, the Relationships table has the columns (OntologyName, Term1, Relation, Term2, . . . ).

To illustrate the processing, we use the restaurant guide example. The data in the restaurant and served_food tables is shown below:

restaurant

| Id | Name | price_range | . . . |
|---|---|---|---|
| 1 | Mac | $ | |
| 2 | Chilis | $$ | |
| 3 | Anthonys | $$$ | |
| 4 | BK | $ | |
| 5 | Uno | $$ | |
| 6 | Wendys | $ | |
| 7 | Dabin | $$ | |
| 8 | Cheers | $$ | |
| 9 | KFC | $ | |
| 10 | Sizzlers | $$ | |
| 11 | Rio | $$ | |
| 12 | Maharaj | $$ | |
| 13 | Dragon | $$ | |
| 14 | Niva | $$ | |

served_food

| R_id | cuisine |
|---|---|
| 1 | American |
| 2 | Mexican |
| 2 | American |
| 3 | American |
| 4 | American |
| 5 | American |
| 5 | Italian |
| 6 | American |
| 7 | Korean |
| 7 | Japanese |
| 8 | American |
| 9 | American |
| 10 | American |
| 11 | Brazilian |
| 12 | Mexican |
| 12 | Indian |
| 13 | Chinese |
| 14 | Portuguese |

3.2.1 Handling Simple Terms. Consider a query that has simple relation types, i.e., no AND, OR, NOT operators. The first query given in Section 2.3.4 can be converted as follows:

Original Query:

```
SELECT r.name, r.address FROM served_food sf, restaurant r
  WHERE r.id = sf.r_id AND
  ONT_RELATED(sf.cuisine, ‘IS_A’, ‘Latin American’,
  Cuisine_ontology’)=1;
```

Transformed Query:

```
SELECT r.name, r.address
FROM served_food sf,restaurant r
WHERE r.id = sf.r_id AND
  sf.cuisine IN (SELECT term1 FROM relationships
START WITH
  term2 = ‘Latin American’ AND relation = ‘IS_A’
    CONNECT BY
PRIOR term1 = term2 AND relation = ‘IS_A’);
```

The text in boldface above is the portion that has been converted. Basically, the third argument is translated into START WITH clause and the second argument into CONNECT BY clause. The result for this query is as follows:

Query Result

| NAME | ADDRESS |
|---|---|
| Chilis | |
| . | |
| . | |
| . | |
| Maharaj | |
| . | |
| . | |
| . | |
| Niva | . . . |

3.2.2 Handling OR Operator. Consider a case where ‘Brazilian’ cuisine was not originally included in the ontology and is now inserted under the ‘South American’ cuisine. Also, to put ‘South American’ cuisine in the same category as ‘Latin American’ cuisine, the transitive and symmetric ‘EQV’ relationship is used as shown in FIG. 3:

Now, to get ‘Latin American’ cuisine, disjunctive conditions should be used to traverse both relationship links, that is, ‘IS_A’ and ‘EQV’. Such disjunctive conditions can be directly specified in the START WITH and CONNECT BY clauses.

Original Query:

```
SELECT r.name, r.address FROM served_food sf, restaurant r
  WHERE r.id = sf.r_id AND
ONT_RELATED(sf.cuisine,
  ‘IS_A OR EQV’,
  ‘Latin American’,
‘Cuisine_ontology’)=1;
```

Transformed Query:

The only differences from the transformed query of the previous example is that the relationships table:

FROM relationships is replaced by a sub-query to introduce the implicit symmetric edges into the query:

```
FROM (SELECT term1, relation, term2
    FROM relationships
    UNION
    SELECT term2, relation, term1
    FROM relationships
    WHERE relation = ‘EQV’)
```

and the occurrence of the following predicate in START WITH and CONNECT BY clauses relation=‘IS_A’
is replaced with the following predicate:
(relation=‘IS_A’ OR relation=‘EQV’)

3.2.3 Handling AND operator. Conjunctive conditions between transitive relationship types can be handled by independently computing the transitive closure for each relationship type and then applying set INTERSECT on the resulting sets. For each node in the intersection, a path exists from the start node to this node for each relationship type and hence this is sufficient.

Let us consider another relationship between cuisines, which identifies the spiciest cuisine using the term MOST_SPICY. The ontology can now contain information such as ‘South Asian cuisine is MOST_SPICY Asian cuisine’ and ‘Indian cuisine is MOST_SPICY South Asian cuisine,’ etc.

To find very spicy cuisine from the ontology, user can issue a query using conjunctive conditions in the relationships as follows:

Original Query: Find a restaurant that serves very spicy Asian cuisine.

```
  SELECT r.name FROM served_food sf, restaurant r
WHERE r.id = sf.r_id AND
ONT_RELATED(sf.cuisine,
  ‘IS_A AND MOST_SPICY’
  ‘Asian’,
  ‘Cuisine_ontology’) = 1;
```

Transformed query:

```
SELECT r.name FROM served_food sf, restaurant r
WHERE r.id = sf.r_id AND
  sf.cuisine IN
(
SELECT term1 FROM relationships
START WITH
term2 = ‘Asian’ AND
    relation = ‘IS_A’
    CONNECT BY
PRIOR term1 = term2 AND
  relation = ‘IS_A’
INTERSECT
  SELECT term1 FROM relationships
  START WITH
    term2 = ‘Asian’ AND
    relation = ‘MOST_SPICY’
      CONNECT BY
PRIOR term1 = term2 AND
relation =‘MOST_SPICY’);
```

3.2.4 Handling NOT operator. A NOT operator specifies which relationships to exclude when finding transitive closure. Therefore, given the start node all relationships except ones specified in NOT operator will be traversed. NOT operators can be directly specified in the START WITH and CONNECT BY clauses.

Original Query: Find all Latin American cuisine, excluding ‘EQV’ relationship types.

```
SELECT r.name FROM served_food sf, restaurant r
WHERE r.id = sf.r_id AND
  ONT_RELATED(sf.cuisine,
    ‘NOT EQV’,
    ‘Latin American’,
    ‘Cuisine_ontology’)=1;
```

Transformed Query: Only difference from the transformed query of the example in Section 3.2.1 is that the occurrence of the following predicate in START WITH and CONNECT BY clauses
relation=‘IS_A’
is replaced with the following predicate:
relation!=‘EQV’

Note that if a user wants to retrieve all cuisines except Latin American cuisine, then the query can be formulated using the operator ONT_RELATED returning 0 as follows:

```
  ......
  ONT_RELATED(sf.cuisine,
    ‘IS_A’,
    ‘Latin American’,
‘Cuisine_ontology’)=0;
```

3.2.5 Handling Combination of OR, AND, and NOT. OR and NOT operators are directly specified in the CONNECT BY clause and AND operators are handled by INTERSECT. All conditions are rewritten as conjunctive conditions. For example, ‘A OR (B AND C)’ will be converted into ‘(A OR B) AND (A OR C).’ Then, ‘(A OR B)’ and ‘(A OR C)’ are specified in the CONNECT BY clause in separate queries that can be combined with INTERSECT operator.

3.3 Speeding up ONT_RELATED and ONT_EXPAND Operations

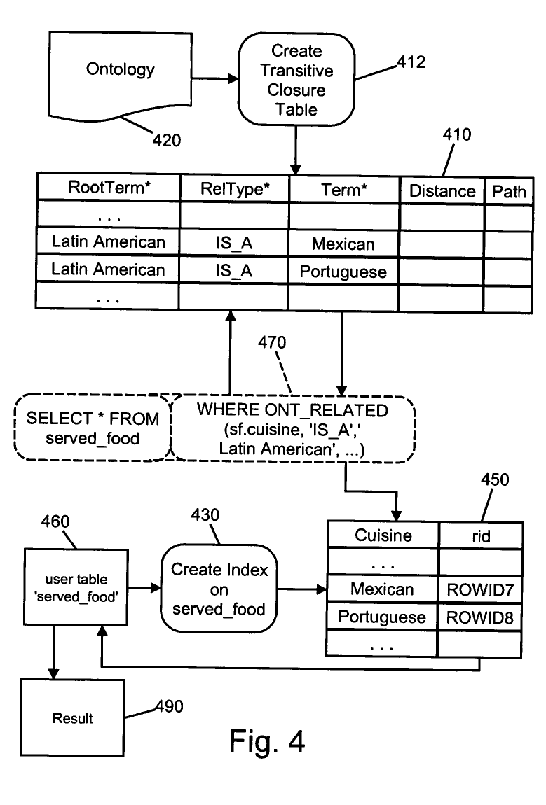

Finding transitive closure from an ontology can be a time-consuming process especially if the ontology has a large number of terms. In addition, different relationship types can further increase the computation cost. To address this problem, a transitive closure table is pre-computed as shown at 412 in FIG. 4. Note that as part of this computation both distance and path measures are computed as well. For the example cuisine ontology, the transitive closure table will be as shown in Table 3 below and at 410 in FIG. 4.

TABLE 3
Transitive Closure Table

| RootTerm | RelType | Term | Distance | Path |
|---|---|---|---|---|
| . | | | | |
| . | | | | |
| . | | | | |
| Latin | IS_A | Mexican | 1 | . . . |
| American | | | | |
| Latin | IS_A | Portuguese | 1 | . . . |
| American | | | | |
| . | | | | |
| . | | | | |
| . | | | | |

The data is stored in a key compressed index-organized table (primary B⁺-tree) with <RootTerm, RelType, Term> as the key. The commonly occurring <RootTerm, RelType> prefixes are compressed. The distance and path are stored as overflow-resident columns. This allows for basic index-structure to remain compact thereby providing efficient index-lookup.

For a query involving ONT_EXPAND, say with arguments ‘Latin American’ and ‘IS_A’ this pre-computed transitive closure table is looked up instead of traversing the ontology to find the transitive closure, and the matching rows are returned. The rows returned include the distance and path measures, which are also available in the Transitive Closure table.

To speed up queries involving ONT_RELATED, a new indexing scheme ONT_INDEXTYPE is implemented using Oracle's Extensible Indexing Framework. Users only need to create an index on the column holding ontology terms using ONT_INDEXTYPE as follows:

CREATE INDEX <index_name>
ON <table_name> (<term_column>)
INDEXTYPE is ONT_INDEXTYPE
PARAMETERS(‘Ontology=<ontology_name>’);

The basic processing of indexing scheme works as follows. Consider the following index creation statement:

CREATE INDEX idx1
ON served_food (cuisine)
INDEXTYPE is ONT_INDEXTYPE
PARAMETERS(‘Ontology=cuisine_ontology’);

The index creation results in creation of a key-compressed index-organized table with two columns <cuisine, row_id> as shown in Table 4, also seen at 450 in FIG. 4. The row_id column contains the row identifier for the served_food table.

TABLE 4
Index Table

| cuisine | row_id |
|---|---|
| . | |
| . | |
| . | |
| Mexican | ROWID7 |
| Portuguese | ROWID8 |
| . | |
| . | |
| . | |

Now, a query involving ONT_RELATED operator say with arguments (sf.cuisine, ‘IS_A’, ‘Latin American’, . . . ), shown at 470 in FIG. 4, is executed by first searching the transitive closure table 410 using the key (‘Latin American’, ‘IS_A’) to find the terms, and then for each term the corresponding row identifier is obtained by doing a lookup into the Index Table 450.

If a query with ONT_RELATED operator references ONT_DISTANCE and/or ONT_PATH, then the indexed implementation of ONT_RELATED operator retrieves distance and/or path measures from the transitive closure table. These values are simply returned as part of ONT_DISTANCE and ONT_PATH invocations.

The index idx1 created on served_food table behaves likes a regular index, which can be incrementally maintained. That is, if a new row is added to served_food table, the corresponding <cuisine, row_id> values are added to the index table. Similarly, the delete and update operations also result in incremental maintenance of the index.

The transitive closure table is meant for a stable ontology. If the ontology changes, the table needs to be updated. For inserts/deletes/updates into ontology, the transitive closure table can be incrementally maintained.

5. Conclusion

For the semantic match operations, consulting ontologies and computing transitive closure can be very time consuming. The proposed mechanism of pre-computing transitive closure table and using that to return results can significantly speed up the semantic match operations.

It is to be understood that the specific examples described above are merely illustrative applications of the principles of the invention. Numerous modifications may be made to the methods, data structures and SQL statements that have been presented without departing from the true spirit and scope of the invention.

What is claimed is:

1. A method for rapidly identifying terms that are associated with a given root term by a transitive relationship defined by hierarchical ontology data stored in a relational database, said method comprising the steps of:
creating a transitive closure table comprising a plurality of rows each of which specifies a term and an associated one of a plurality of root terms, said table being sorted and indexed by said root terms to group together rows associated with each of said root terms, and
consulting said transitive closure table to identify terms associated with said given root term.

2. A method for rapidly identifying terms as set forth in claim 1 wherein said transitive closure table comprises the a plurality of rows, each of which contains a root term and a term associated with said root term coupled by one or more relationship links specified by said hierarchical ontology data.

3. A method for rapidly identifying terms as set forth in claim 2 wherein each of said plurality of rows further includes a value specifying the type of relationship that exists between the root term and the associated term specified in that row.

4. A method for rapidly identifying terms as set forth in claim 3 wherein step of consulting said transitive closure table to identify terms associated with said given root term includes the step of searching for rows including the specification of said a specific root term and a specific type of relationship.

5. A method for rapidly identifying terms as set forth in claim 3 wherein said step of consulting said transitive closure table includes searching for a specific type of relationship.

6. A method for rapidly identifying terms as set forth in claim 2 wherein each of said plurality of rows further includes a value specifying a measure of the path distance by which the root term and the term associated with said root term specified in that row are coupled by said one or more relationship links.

7. A method for rapidly identifying terms as set forth in claim 6 wherein said step of consulting said transitive closure table to identify terms associated with said given root term yields said distance measure.

8. A method for rapidly identifying terms as set forth in claim 1 wherein said step of consulting said transitive closure table to identify terms associated with said given root term is performed in response to the submission of an SQL query which requests the identification of rows in one or more data tables that include terms that are associated with said given root term.

9. A method for rapidly identifying terms as set forth in claim 8 wherein each of said plurality of rows further includes a value specifying the type of relationship that exists between the root term and the associated term specified in that row and wherein said SQL query specifies a specific type of relationship.

10. The method for processing data stored in a relational database comprising, in combination, the steps of:
storing at least some of said hierarchical ontology data in a relationships table that contains a plurality of rows, each of which identifies a pair of terms joined by a relationship link,
processing said relationships table to create and persistently store a transitive closure table that contains a plurality of rows, each of which contains a root term and a term associated with said root term by a path of one or more of said relationship links, and
executing a database query that consults said transitive closure table to identify terms associated with a particular root term specified in said query.

11. The method for processing data stored in a relational database as set forth in claim 10 wherein each of said plurality of rows in said transitive closure table specifies a relationship type for said path of one or more relationship links and wherein said database query specifies a relationship type by which said terms are associated with said particular root term specified in said query.

12. The method for processing data stored in a relational database as set forth in claim 10 wherein said query is an SQL SELECT query that includes the identification of an semantic matching operator that consults said transitive closure table.

13. The method for processing data stored in a relational database as set forth in claim 12 wherein said SELECT query requests the identification of rows in one or more data tables stored in said relational database that include terms that are associated with said particular root term.

14. The method for processing data stored in a relational database as set forth in claim 13 wherein each given row in said relationships table further includes a value specifying the type of the relationship link specified in said given row and wherein each row in said transitive closure table includes a value specifying the type of the relationship defined by said path.

15. The method for processing data stored in a relational database as set forth in claim 14 wherein said SELECT query consults said transitive relationship table to identify terms associated with said particular root term by a type of relationship specified in said SELECT query.

16. The method for processing data stored in a relational database as set forth in claim 10 wherein each of said plurality of rows in said transitive closure table further includes a value specifying a measure of the path distance by which the root term and the term associated with said root term specified in that row are coupled by said path.

17. The method for processing data stored in a relational database as set forth in claim 16 wherein said step of executing said query that consults said transitive closure table includes the step of producing said value specifying a measure of the path distance.

18. The method for increasing the speed of execution of relational database queries which consult ontology data and at least one relational data table, said method comprising, in combination, the steps of:
before the execution of said queries, creating a transitive closure table by processing said ontology data to generate a first set of table rows, each of which contains a root term and an additional term associated with said root term,
before the execution of said queries, creating a term-to-row-identifier mapping table by processing said relational data table to generate a second set of table rows, each of which contains a given term and the identification of a row in said relational data table that contains said given term, and
during the execution of each of said queries, consulting said transitive closure table and said term-to-row-identifier table to identify rows in said relational data table which contain terms that are related to a term specified in said query by said ontology data.

19. The method for increasing the speed of execution of relational database queries as set forth in claim 18 wherein each of said first set of table rows in said transitive closure table further includes the specification of a relationship type and wherein multiple rows in said first set of rows specifying the same root term and relationship type together represent a transitive closure.

20. The method for increasing the speed of execution of relational database queries as set forth in claim 18 wherein each of said first set of table rows contains a values indicating a measure of the relationship linking path which associates said root term and said additional term specified in that table row.
